(19) United States
(12) Patent Application Publication
(10) Pub. No.: US 2026/0339747 A1
(43) Pub. Date: Oct. 29, 2026

(54) INTELLIGENT VOLUME PROVISIONING WITH VIRTUAL CSI DRIVER

(71) Applicant: Dell Products, L.P., Round Rock, TX (US)

(72) Inventors: Harish Prabhakara, Bangalore (IN); Francis Wilfred Nijay, Chennai (IN); Harshita Pandey, Nainital (IN); Thomas Watson, Richardson, TX (US)

(21) Appl. No.: 19/192,048

(22) Filed: Apr. 28, 2025

(51) Int. Cl. G06F 9/50; G06F 11/34

(52) U.S. Cl. CPC G06F 9/5077; G06F 9/5044; G06F 11/3409

(57) ABSTRACT

Architectures and techniques are described for unifying heterogeneous storage systems within a single Container Storage Interface (CSI) driver in container-based computing environments. Such can eliminate the need for multiple CSI drivers by integrating vendor-specific drivers as libraries under one driver framework, thus enabling seamless provisioning across block-based, file-based, object-based, hyperconverged, or other storage architectures. Performance metrics (e.g., capacity, IOPS, network latency) from each storage back end are used to classify the storage systems into tiers. Based on these classifications a provisioning decision is made, selecting the best-fit storage system automatically. A minimal set of storage classes accommodates either fully automated, semi-intelligent, or manually specified provisioning, thereby reducing administrative overhead. The system can leverage node-level connectivity information to ensure that volumes attach to nodes that support the chosen protocol and array, providing a comprehensive, data-driven approach to heterogeneous storage management.

### BACKGROUND

Containerization is a lightweight virtualization technique that provides high consistency, operating systems distribution portability, efficient resource management, and consistency across multiple environments. Thus, applications or application programming interfaces (APIs) can be containerized to provide numerous benefits to service providers and their subscribers. Due to the many benefits of containerization, many container orchestration (CO) systems and associated products have entered the marketplace to help automate and orchestrate containerization. One such example product is Kubernetes. Kubernetes is an open-sourced software tool that can effectively manage containerized applications with reduced manual intervention.

Container Storage Interface (CSI) is a standard for exposing an arbitrary storage system to containerized workloads on CO systems like Kubernetes or others. CSI enables storage vendors to develop a plugin once and have the plugin work across multiple CO systems, without requiring modifications to the core CO code.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a schematic block diagram illustrating an example container orchestration (CO) system using container storage interface (CSI) drivers to interface to a storage system in accordance with certain embodiments of this disclosure;

FIG. 2A depicts schematic diagram illustrating various examples of a storage system type associated with a given storage system in accordance with certain embodiments of this disclosure;

FIG. 2B depicts schematic diagram illustrating various examples of a storage system communication protocol associated with a given storage system in accordance with certain embodiments of this disclosure;

FIG. 3 depicts, a schematic block diagram is depicted illustrating an example CO system that can leverage a single virtual container storage interface (vCSI) driver to provision volumes across heterogeneous storage systems irrespective of the type, vendor, protocol or other storage system characteristic in accordance with certain embodiments of this disclosure;

FIG. 4 depicts a schematic block diagram illustrating an example device that can leverage a single vCSI driver to provision volumes across heterogeneous storage systems regardless of the type, vendor, protocol, or other storage system characteristic in accordance with certain embodiments of this disclosure;

FIG. 5 depicts a schematic block diagram illustrating additional elements or aspects of the example device that can leverage a single vCSI driver to provision volumes across heterogeneous storage systems regardless of the type, vendor, protocol, or other storage system characteristic in accordance with certain embodiments of this disclosure;

FIG. 6 depicts a schematic flow diagram illustrating an example process flow relating to determining node label information via NodeGetInfo calls in accordance with certain embodiments of this disclosure.

FIG. 7 depicts a schematic flow diagram illustrating an example process flow relating to suitable storage arrays and determining topology in accordance with certain embodiments of this disclosure;

FIG. 8 depicts a flow diagram illustrating an example process flow resulting from an example use case of the vCSI driver in accordance with certain embodiments of this disclosure;

FIG. 9 illustrates an example method that can leverage a single vCSI driver to provision volumes across heterogeneous storage systems regardless of the type, vendor, protocol, or other storage system characteristic in accordance with certain embodiments of this disclosure;

FIG. 10 illustrates an example method that can provide additional aspects or elements relating to leveraging single vCSI driver to provision volumes across heterogeneous storage systems regardless of the type, vendor, protocol, or other storage system characteristic in accordance with certain embodiments of this disclosure;

FIG. 11 illustrates a block diagram of an example distributed file storage system that employs tiered cloud storage in accordance with certain embodiments of this disclosure; and

FIG. 12 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

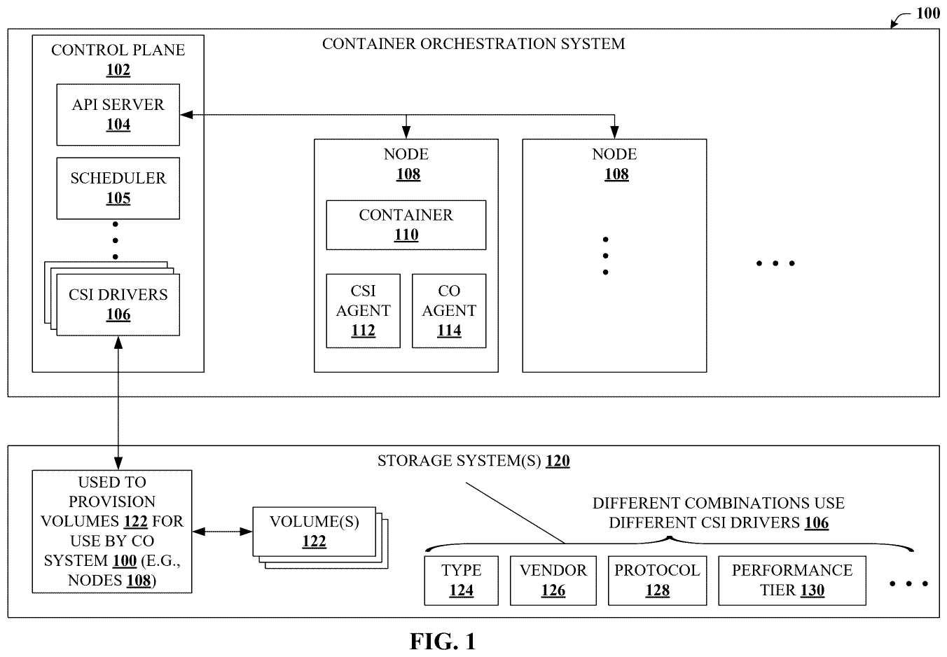

To provide additional context, consider FIG. 1. FIG. 1 shows a schematic block diagram illustrating an example container orchestration (CO) system that uses respective container storage interface drivers to interface to different storage systems in accordance with certain embodiments of this disclosure. For example, CO system 100 can represent a container orchestration platform cluster or the like. As a representative example used for the remainder of this document, CO system 100 is presented in the context (e.g., operation and nomenclature) of a Kubernetes system, which, today, is the most widely used enterprise container orchestration system or platform. However, it is appreciated that the disclosed techniques can be applied to any suitable container orchestration platform, which may have different functional approaches or use different nomenclature to refer to similar functional elements. That is, the disclosed techniques can be suitably applied to any container orchestration system or platform or another system or platform that implements the functional element detailed herein.

As illustrated, CO system 100 can comprise control plane 102 and one or more nodes 108. In some embodiments, control plane 102 can be a master node and nodes 108 can represent worker nodes. Control plane 102 can operate to manage and coordinate the lifecycle of containers (e.g., container 110) across a cluster of nodes 108. Control plane 102 can act as a centralized authority, enforcing policies, and ensuring consistency and reliability across the distributed environment.

Control plane 102 can comprise application programming interface (API) server 104 and many other elements including a scheduler 105 or the like. Moreover, particular to the disclosed subject matter, control plane 102 can comprise container storage interface (CSI) drivers 106. API server 104 can serve as the primary interface for interacting with control plane 102 and submitting requests to manage the cluster. API server 104 can expose a RESTful API, enabling clients to communicate with the control plane and perform various operations. Scheduler 105 can be responsible for efficiently allocating and managing container resources across a cluster of nodes, including, e.g., workload scheduling, node 108 selection, container 110 placement, resource allocation, and event handling.

CSI driver 106 can represent a software component, conforming to a CSI specification, that enables the CO system 100 (e.g., Kubernetes) to interact with various storage systems 120, which can be vendor-specific in terms of architecture and operation. As illustrated here, storage system 120 can comprise one or more volumes 122 that can be interacted with via CO system 100. One or more volume 122 can be included on a single physical drive or storage device such as a hard disk drive (HDD), a solid state drive (SSD), or other drive types.

Regardless, CSI driver 106 can act as a bridge between container orchestration platforms (e.g., CO system 100) and the underlying storage infrastructure (e.g., storage systems 120), allowing CO system 100 to provision, attach, and manage storage volumes 122 for use by CO system 100. CSI drivers 106 can be responsible for implementing the CSI specification, which defines a set of APIs and protocols for storage systems to communicate with container orchestration platforms like Kubernetes. As illustrated here, as one result, CSI drivers 106 can allow CO system 100 to provision and use volumes 122 of a given storage system.

In this context and as used herein, ‘provisioning’ can refer to the process of allocating, configuring, and making a storage volume available to containerized workloads of CO system 100 through a CSI driver 106. More concretely, provision can involve creating a new volume 122 (or “drive”) on a chosen storage system 120, applying any requested size or performance attributes, and then exposing that volume 122 so that Kubernetes (or another container orchestrator) can mount it to a pod. Essentially, provisioning can refer to carving out space on an underlying storage system 120 and presenting that storage space in a usable form to meet the storage requirements of a containerized application.

To these or other ends, CO system 100 can comprise CSI agents (e.g., CSI agent 112) and CO agents (e.g., CO agent 114), which can also be referred to as sidecar containers. Typically, CSI agents 112 are a type of container that runs alongside CSI driver 106. A primary responsibility of CSI agent 112 can be to watch for CO system 100 events, such as volume attachment or detachment events, and trigger the corresponding actions on storage system 120 using CSI driver 106. CSI agents can come in two types, namely a controller agent (not shown) that runs on control plane 102 and watches for event objects, and a node agent (e.g., CSI agent 112) that runs on nodes 108 looking for associated event objects. Apart from storage-specific operations, CO agent 114 can operate to automate the deployment, management, and scaling of containerized applications.

Because storage systems are generally vendor-specific, CSI drivers 106 are typically developed by storage vendors or third-party developers to support specific storage systems 120, such as block storage, file systems, or object storage. CSI drivers 106 can be containerized and deployed as part of the CO system 100 (e.g., Kubernetes) cluster, allowing CO system 106 to discover and register the available storage systems.

Hence, using CSI driver 106, third-party storage providers (e.g., vendors) can write and deploy plugins exposing new storage systems in Kubernetes (or other CO system 100) without ever having to touch the core Kubernetes code. For example, CSI drivers 106 can expose a rich set functionality to manage volumes, such as: dynamic provisioning and deprovisioning of a volume 122, attaching or detaching a volume 122 from a node 108, mounting/unmounting a volume 122 from a node 108, and so on.

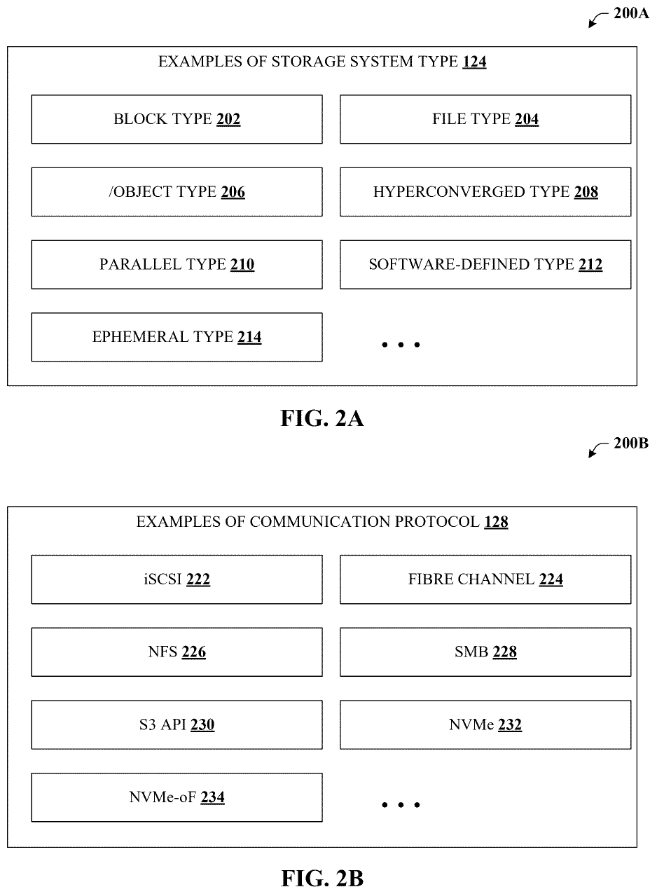

On challenge that arises is that each storage provider (e.g., vendor) can have a variety of heterogeneous storage systems 120, each of which can be leveraged by customers based on the customer's specific need. Each respective storage system 120 can differ in terms of type 124 (also referred to herein as storage system type 124 further detailed in connection with FIG. 2A), vendor 126, protocol 128 (also referred to herein as communication protocol 128 further detailed in connection with FIG. 2B), performance tier 130 (e.g., diamond, platinum, gold, silver, . . . ), or other characteristics.

While still referring to FIG. 1, but turning now as well to FIGS. 2A and 2B, further detail is provided in connection with certain characteristics of a given storage system 120. In that regard, FIG. 2A depicts schematic diagram 200A illustrating various examples of a storage system type 124 associated with a given storage system 120 in accordance with certain embodiments of this disclosure. FIG. 2B depicts schematic diagram 200B illustrating various examples of a storage system communication protocol 128 associated with a given storage system 120 in accordance with certain embodiments of this disclosure.

Referring specifically to FIG. 2A, illustrated are exemplary storage system types 124 in the form of block type 202, file type 204, object type 206, hyperconverged type 208, parallel type 210, software-defined type 212, and ephemeral type 214. It is understood that the provided examples are for illustrative purposes and do not represent an exhaustive list. Block type 202 includes traditional block-oriented storage arrays that present volumes as raw block devices. Such devices are often accessed via protocols like Internet small computer systems interface (iSCSI) or Fibre Channel, providing direct block-level read/write commands.

File type 204 offers shared file systems that store and organize data using directories and files, usually accessed through network protocols such as network file system (NFS) or server message block (SMB). Object type 206 encompasses storage solutions that manage data as objects with metadata and identifiers rather than hierarchically in files, frequently exposing an API similar to Amazon S3. Hyperconverged type 208 combines compute, networking, and storage into a single cluster or node-based platform, distributing data across shared resources while often providing block or file services within the same software stack.

Parallel type 210 can be characteristic of high-performance computing (HPC) environments, where a parallel file system allows multiple clients to access data simultaneously, improving throughput for large datasets. Software-defined type 212 abstracts the underlying physical storage by implementing advanced functions like replication or scaling in software. Ephemeral type 214 can include local storage that exists only for the duration of a container or node lifecycle, where the storage can be tightly coupled to a particular host and is not intended for long-term persistence.

Specifically referring to FIG. 2B, depicted are examples of communication protocol 128, comprising iSCSI 222, fibre channel 224, NFS 226, SMB 228, S3 API 230, non-volatile memory express (NVMe) 232, and non-volatile memory express over fabrics (NVMe-oF) 234. It is understood that the provided examples are for illustrative purposes and do not represent an exhaustive list.

The iSCSI 222 protocol can carry SCSI commands over transport control protocol (TCP)/Internet protocol (IP) networks, enabling block-level transfers across standard Ethernet. Fibre channel 224 is a high-speed enterprise storage networking standard that transports SCSI commands over dedicated fiber channel fabrics, commonly deployed in SAN environments. NFS 226 refers to the Network File System protocol, allowing file-level sharing of data across a network and widely used in Unix or Linux environments. SMB 228 (also known as CIFS) is a file-sharing protocol commonly found in Windows environments, facilitating remote file access with permissions and authentication. S3 API 230 can be representative of object-based data operations, enabling PUT, GET, and DELETE actions against storage systems that expose S3-compatible endpoints. NVMe 232 is a protocol designed for high-speed communication with non-volatile memory devices, typically used locally on PCIe-connected solid-state drives. NVMe-oF 234 extends NVMe over a network fabric such as Ethernet or RDMA, delivering low-latency performance comparable to local NVMe drives while offering shared networked storage.

Still referring to FIG. 1, due to the many potentially different characteristics of a given storage system 120 discussed in connection with FIGS. 2A and 2B and elsewhere herein, a first storage system 120 may provide cutting edge performance (e.g., generally at a higher cost), a second storage system may provide mid-range performance, a third storage system may provide lower-end performance (e.g., generally at a lower cost), and so forth. Based on the needs of the CO system 100, mission critical workloads of the customer can be assigned to the first storage system 120, while batch jobs or the like are handled by the third storage system. Thus, a single vendor typically maintains multiple different, heterogeneous, storage systems 120 and in some cases a single customer might apportion CO system workloads among multiple different vendors (e.g., vendor 126).

As a result, customers that leverage multiple different storage systems rely on the installation of multiple different CSI drivers 106. As indicated in FIG. 1, each of the different characteristics (e.g., type 124, vendor 126, protocol 128, . . . ) of a given storage system 120 can use a different CSI driver 106 and can further use a different storage class for provisioning volumes 122. Unfortunately, provisioning volumes 122 is a manual process. An administrator is expected to find and explicitly specify the storage class for each volume provisioning action.

To these and other related ends, the disclosed subject matter addresses various challenges of managing storage systems 120 from multiple providers having multiple types 124 and multiple protocols 128 (or other storage system characteristics) in container-based environments. Conventionally, each type of storage, whether provided by different vendors, running on different protocols, or possessing other unique features, requires a dedicated CSI driver 106. As a result, administrators are expected to install and maintain multiple drivers and create multiple storage classes for each separate storage environment, which complicates operations and can lead to inefficient provisioning decisions. By contrast, the present solution consolidates these diverse back ends into a single, unified CSI driver that can dynamically gather real-time metrics and can apply an intelligent decision-making framework for allocating volumes. This approach can eliminate the need to manage multiple CSI drivers 106 or manually identify which storage system 120, protocol 128, or configuration should be used for each volume request, thereby substantially simplifying storage provisioning, reducing administrative overhead, and enabling more informed, data-driven choices regarding how and where volumes 122 are placed.

### Example Systems

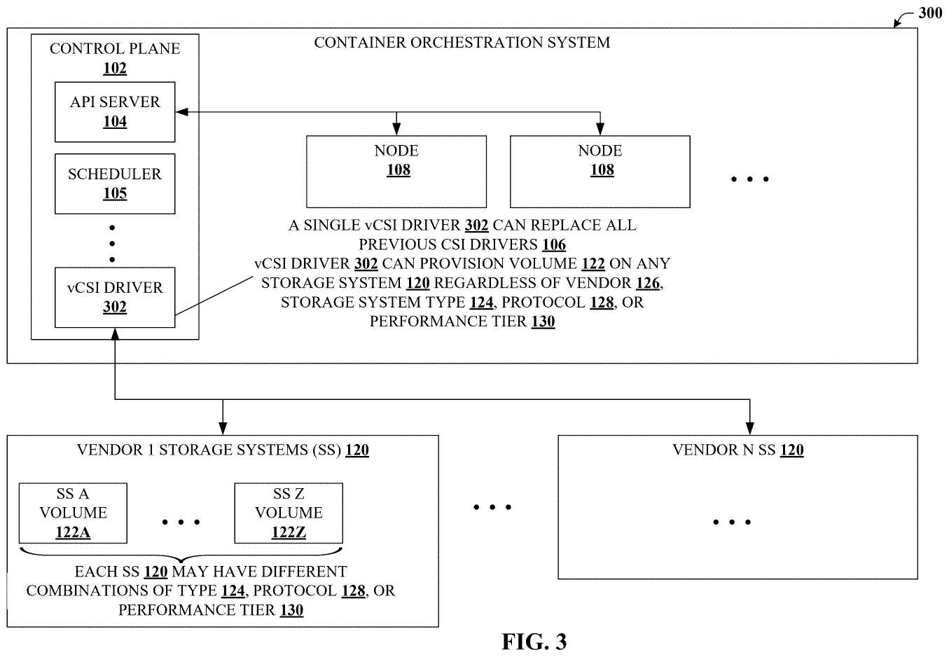

With reference now to FIG. 3, a schematic block diagram is depicted illustrating an example CO system 300 that can leverage a single virtual container storage interface (vCSI) driver 302 to provision volumes across heterogeneous storage systems irrespective of the type, vendor, protocol or other storage system characteristic in accordance with certain embodiments of this disclosure. As illustrated, this single vCSI driver 302 can effectively replace all previous CSI drivers 106, thereby significantly reducing the potential inefficiencies of provisioning volumes 122 for use by CO system 300.

Thus, the single vCSI driver 302 can be used to provision volumes 122 across multiple vendors 126 and across heterogeneous storage systems 120 of a single vendor 126 such as when a single vendor 126 provides multiple different storage systems 120 having different characteristics such as type 124, protocol 128, performance tier 130, and so forth. As illustrated here, Vendor 1 can provide any number of different storage systems 120 (e.g., each one having different combinations of certain storage system characteristics), labeled as storage system (SS) A through SS Z. vCSI driver 302 can provision associated volumes 122A-122Z on any one of those heterogeneous storage systems 120. vCSI driver 302 can further provision volumes 122 on other storage systems 120 provided by other vendors such as Vendor N SS 120.

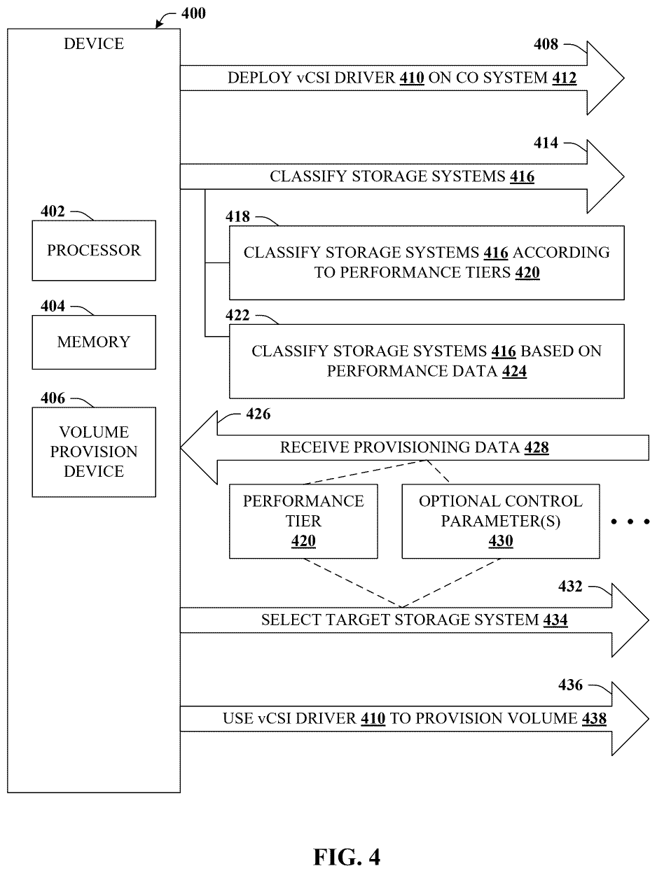

Hence, vCSI driver 302 can, in some embodiments, provide fully automated intelligent volume placement. In some embodiments (as will be further detailed below and also in connection with FIG. 4) optional control parameters can be used to facilitate additional control by administrators so that provisioning can be specified in an semi-intelligent or even fully manual manner.

In connection with the volume placement automation, real-time metrics (e.g., capacity, IOPS, latency) can be collected for all configured storage systems 120. Further, a supervised learning model (e.g., Random Forest) can be leveraged to categorize storage systems 120 into various performance tiers 130. Examples of such can be performance tiers such as diamond, platinum, gold, silver, or the like to provide shorthand characterization of various performance levels and/or costs.

In some embodiments, vCSI driver 302 can rely on minimal storage classes to provision volumes across storage systems. For instance, the storage class can contain a field “Provisioning Tier” (e.g., diamond, platinum, gold, silver, . . . ) based on which provisioning can be selected from the available storage systems that are specified in the Virtual CSI configuration. A minimal set of storage classes is sufficient because a user can specify a provisioning tier or optional parameters (e.g., protocol, storage array ID, storage pool), and the system can automatically map to the correct underlying storage system. Based on the above, vCSI driver 302 can thus select the best fit for a volume 122 based on real-time data.

Hence, instead of manually maintaining multiple drivers for each array or protocol, vCSI driver 302 can import provider-specific CSI drivers 106 as libraries and/or ‘go modules’ and can orchestrate associated operations from a unified interface. Such can thereby enable a single driver for heterogeneous systems. As noted, such can reduce operational overhead and simply CO system 300 storage administration.

As noted, in some embodiments, flexible provisioning modes can be facilitated. For example, administrators can rely on fully automated “intelligent” provisioning, specify certain parameters (e.g., semi-intelligent mode), or manually define storage parameters, if desired.

Furthermore, enhanced node selection on CO system 300 can be provided. For instance, vCSI driver 302 can automatically identify and label nodes (e.g., nodes 108) for each supported protocol or array connectivity. During volume creation, vCSI driver 302 can ensure pods are scheduled to nodes compatible with the selected storage system and protocol. No known CSI driver currently provides both intelligent multi-system provisioning and node selection from a single solution.

Thus, the disclosed subject matter and associated capabilities represent a departure from conventional CSI drivers 106, where each storage system 120 and protocol 128 is handled in isolation. vCSI driver 302 uniquely consolidates heterogeneous storage under a single driver, can apply real-time classification and decision logic to place volumes, and can dynamically select suitable nodes based on array connectivity, thus providing an integrated, intelligent approach to volume provisioning that is not found in other solutions.

In more detail, in some embodiments, vCSI driver 302 can keep track of the available storage systems, associated parameters like available space in each storage pool, input/output operations per second (IOPS), network latency, and available protocols on each storage system on a real-time basis using the storage array APIs.

Based on the above data, vCSI driver 302 can categorize the storage systems into different tiers and as per the “Provisioning Tier” specified in the storage class, and the protocol and the storage system can be selected.

vCSI driver 302 can also allow user to specify any of the parameters from Protocol, Storage Array ID, Storage Pool by which the provisioning can also be semi-intelligent or completely manual.

Below is a sample of the storage class in the context of Kubernetes:
apiVersion: storage.k8s.io/v1
kind: StorageClass
metadata:
   name: vendor-vcsi-iscsi
provisioner: vcsi.vendor.com
reclaimPolicy: Retain
allowVolumeExansion: true
parameters:
   performancePolicy: Diamond
   #Optional Parameters
   FsType: ext4
   Protocol: iSCSI
   tieringPolicy: 1
   hostIOLimitName: hostlimit1
   storagePool: csm1
   arrayID: AAA0000000001

Regarding topology, vCSI driver 302 can support topology in order provision volumes and schedule pods to selective nodes. In cases where a customer's cluster has nodes 108 with multiple protocols, vCSI driver 302 can allow a user to specify a specific protocol based key so that the pod will be scheduled on the node that has the associated label. The labels can be set as result of NodeGetInfo( ) and can be in one of the below format: vcsi-vendor.com/iscsi, vcsi-vendor.com/nfs, vcsi-vendor.com/fc

Below is a sample of the storage class with topology key
apiVersion: storage.k8s.io/v1
kind: StorageClass
metadata:
   name: vendor-vcsi-iscsi
provisioner: vcsi.vendor.com
reclaimPolicy: Retain
allowVolumeExansion: true
parameters:
   performancePolicy: Diamond
#Optional Parameters
allowedTopologies:
   matchLabelExpressions:
      key: “vcsi.vendor.com/iscsi”
      values:
         “true”

Regarding classification, it is appreciated that any suitable model can be used, but as a representative example, a random forest algorithm is detailed herein. Random forest is a supervised machine learning algorithm that builds an ensemble of multiple decision trees trained on various subsets of the data.

Generally speaking, a decision tree is a hierarchical tree-like structure used to make predictions. The idea is to represent data as a tree where internal nodes represent the conditions on the attributes, branches representing the outcome of the conditions, and the leaf nodes hold the class labels. The prediction of each decision tree is considered a vote and the class with maximum number of votes is the prediction of the algorithm in case of classification tasks.

For vCSI driver 302 the input features can be the available parameters, and the class labels can be the different storage systems. The algorithm can use the input features to construct multiple decision trees where each tree will independently classify the storage, and the final class label can determine the majority voting amongst all the trees.

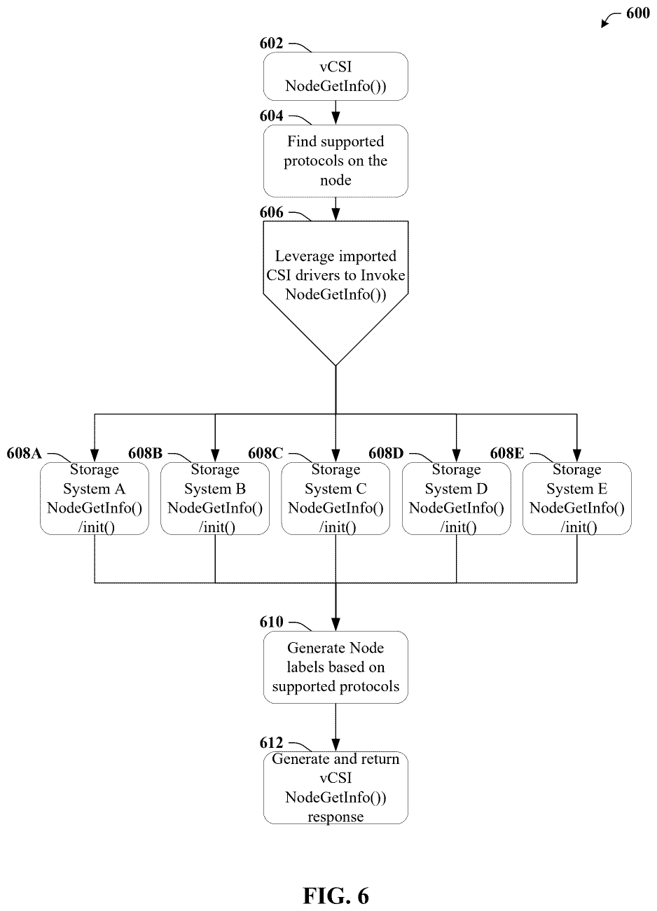

Re-classification of available arrays can be done periodically using real time data parameters like storage capacity of the array, data transfer rate, and others that can be pulled from each array every time the arraylist is updated or at a fixed intervals. vCSI driver 302 can keep track of the nodes in the cluster, the protocol supported by each node, connectivity to each array and can apply node labels accordingly. The array and protocol selected by vCSI driver 302 can also choose a suitable node for provisioning. Further, vCSI driver 302 can perform node selection as well based on the selected array and protocol. During a create volume request, vCSI driver 302 can perform and appropriate selection, generate the selected node label accordingly, and return the label in the create volume response. The above approaches are further detailed in connection with FIGS. 6-8.

With reference now to FIG. 4, a schematic block diagram illustrating an example device 400 that can leverage a single vCSI driver 410 to provision volumes across heterogeneous storage systems regardless of the type, vendor, protocol, or other storage system characteristic in accordance with certain embodiments of this disclosure. In that regard, device 400 can, in some embodiments, be integrated into an orchestration system such as CO system 300, which can be, e.g., a Kubernetes system or another suitable container orchestration platform. In some embodiments, device 400 can be integrated with a control plane of the CO system such as control plane 302.

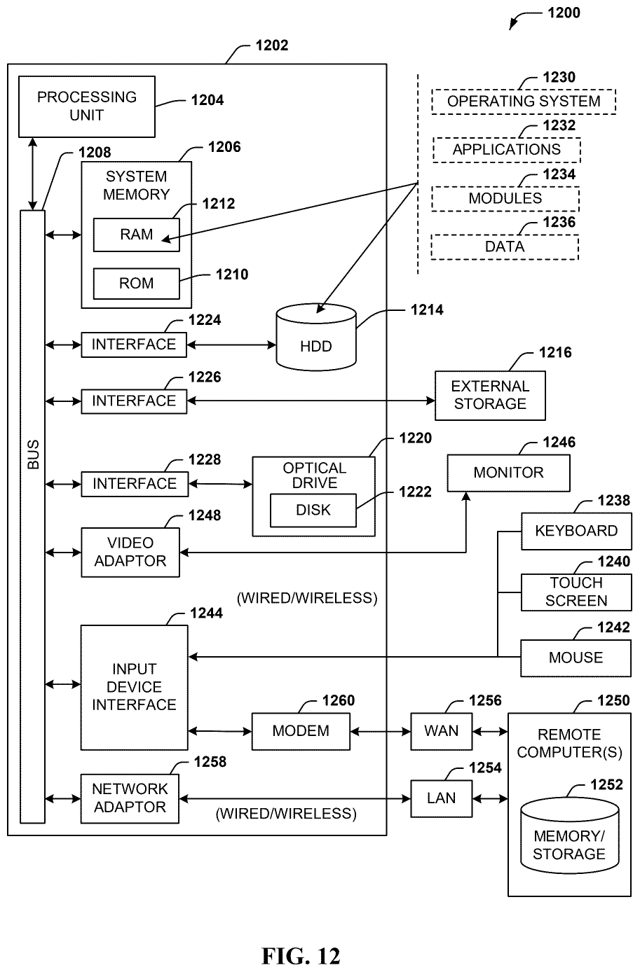

Device 400 can comprise at least one processor 402 that, potentially along with volume provision device 406, can be specifically configured to perform functions associated with provisioning storage volumes for use with a container orchestration platform. Device 400 can also comprise at least one memory 404 that stores executable instructions that, when executed by the at least one processor 402, can facilitate performance of operations. Processor(s) 402 can be a hardware processor having structural elements known to exist in connection with processing units or circuits, with various operations of processor 402 being represented by functional elements shown in the drawings herein that can require special-purpose instructions, for example, stored in memory 404 and/or volume provision device 406. Along with these special-purpose instructions, processor 402 and/or volume provision device 406 can be a special-purpose device. Further examples of the memory 404 and processor 402 can be found with reference to FIG. 12. It is to be appreciated that device 400 or computer 1202 can represent a server device or a client device of a container orchestration services platform and computer 1202 can be used in connection with implementing one or more of the systems, devices, or components shown and described in connection with FIG. 4 and other figures disclosed herein.

As illustrated at reference numeral 408, device 400 can deploy vCSI driver 410 (e.g., vCSI driver 302) on CO system 412 (e.g., CO system 300). As explained, vCSI driver 410 can be configured to provision a storage volume (e.g., volume 122) for use by containerized workloads of CO system 412. vCSI driver 410 can be further configured for use with any one of a group of storage systems 416 (e.g., storage systems 120) having different characteristics. For example, regardless of storage systems be provided by different vendors (e.g., vendor 126), being of different types (e.g., type 124), communicating according to different protocols (e.g., protocol 128), or having distinct performance tiers 420 (e.g., performance tier 130), vCSI driver 410 can be used to intelligently select and provision a volume on any one of these storage systems 416.

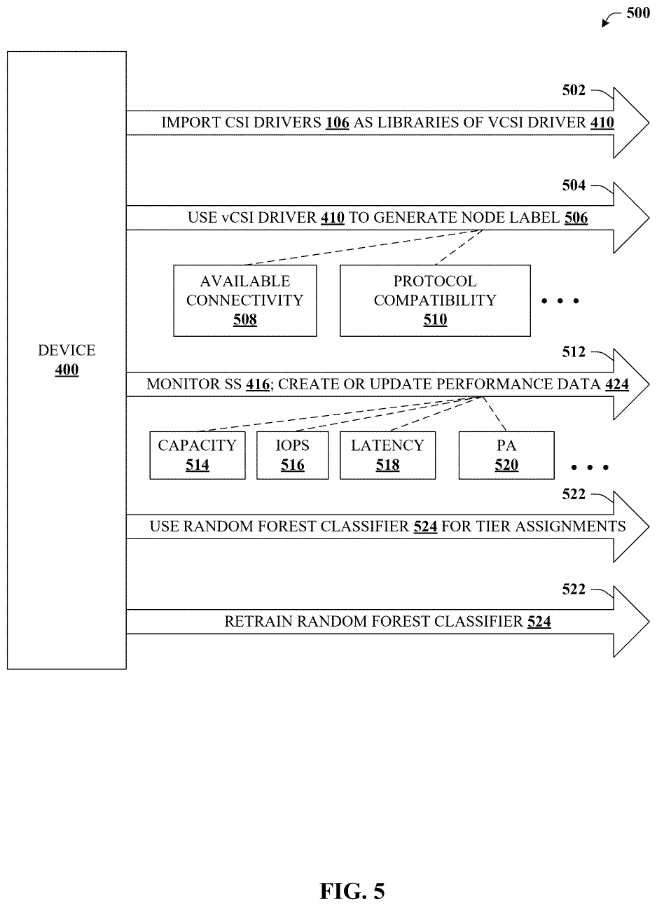

At reference numeral 414, device 400 can be configured to classify the various storage systems 416. As indicated at reference numeral 418, such classification can be based according to designated performance tiers 420. As indicated at reference numeral 422, such classification can be based on performance data 424 associated with the group of storage systems 416, which is further described in connection with FIG. 5.

At reference numeral 426, the device can receive provisioning data 428. Provisioning data 428 can include, for example, a specification of a desired provisioning tier (e.g., linked to performance tier 420 such as diamond, platinum, gold, silver, . . . ) as well as one or more optional control parameters 430. This provisioning tier can represent user-friendly abstraction of the performance requirement or expectation. In that regard, device 400 can map the indicated tier to suitable arrays/pools and protocols based on real-time metrics associated with performance data 424.

Regarding optional control parameters 430, each of these additional parameters, if any, can either complement or override the default intelligent decision-making process, enabling a semi-intelligent (e.g., partially guided) or fully manual provisioning modes that can be determined by administrators or company policy. By way of example, these optional control parameters can include a specific communication protocol 128, an array identifier, a storage pool identifier, and so on. A given storage class might also allow the specification of, e.g., a volume size or capacity indicator, IOPS caps or other performance or topology constraints. For instance, in the case of a capacity indicator, Kubernetes (or other CO system 300) configurations provide this as part of the Persistent Volume Claim, but such can also be defaulted or constrained via the storage class.

At reference numeral 432, device 400 can, based on provisioning data 428 and potentially based on the aforementioned classification and/or performance data 424, select a target storage system 434. Target storage system 434 can be selected from among the group of storage systems 416 that are available. Target storage system 434 can be specifically selected as a best fit or optimal storage system vis-à-vis any identified constraint or request.

In other words, when an administrator creates a storage class, or a Persistent Volume Claim that reference that storage class, containing one or more optional control parameters 430, vCSI driver 410 can use that information to, e.g., filter or rank the available back-end systems (e.g., based on array IDs, protocols, pools, or tiers), match the user's explicit or implied requirements (e.g., performance tier, capacity, . . . ), and provision and expose the resulting volume to the workload on a compatible node.

This flexibility allows for both intelligent (e.g., automated) allocation using real-time metrics and machine learning and manual or semi-automatic provisioning that adheres to custom constraints. Thereafter, as indicated at reference numeral 436, device 400 can utilize vCSI driver 410 to provision volume 438 (e.g., volume 122) on target storage system 434.

Turning now to FIG. 5, a schematic block diagram 500 illustrating additional elements or aspects of the example device 400 that can leverage a single vCSI driver to provision volumes across heterogeneous storage systems regardless of the type, vendor, protocol, or other storage system characteristic in accordance with certain embodiments of this disclosure.

For example, at reference numeral 502, device 400 import all or a portion of CSI drivers 106 as a library of vCSI driver 410. As indicated, CSI drivers 106 can be configured for use with a defined one (e.g., single) of the group of storage systems 416 having a defined storage system type 124 that is associated with a defined vendor 126, and communication according to a defined protocol 128. Because vCSI driver 410 can import many such CSI drivers 106 as libraries, these libraries can be leveraged to subsequently provide provisioning capabilities for substantially any storage system 416.

At reference numeral 504, device 400 can use vCSI driver 410 to generate node label 506. Node label 506 can represent a label for a node 108 of CO platform 300. Node label 506 can indicate useful information such as, e.g., available connectivity 508, protocol compatibility 510, or other suitable storage system characteristics. As such, application of node label 506 can provide an assurance that the storage volume is mounted only on nodes of CO platform 300 that support a type or other characteristics of target storage system 434.

At reference numeral 506, device 400 can monitor storage systems 416 in order to create or update performance data 424. In other words, performance data 424, used by vCSI driver 410 for classification and the like, can be collected (and persistently updated to remain viable) by device 400. Performance data 424 can relate to any suitable performance metric such as, for example, a storage capacity metric 514, a IOPS metric 516, a network latency metric 518, a protocol availability (PA) metric 520, and so forth.

Furthermore, at reference numeral 522, said classification can be accomplished via a supervised machine learning model (SMLM) such as an SMLM comprising a random forest classifier 524. Random forest classifier 524 can generate tier assignments based on real-time metrics associated with performance data 424. In some embodiments, random forest classifier 524 can be retrained or updated at predefined intervals or in response to significant changes in performance data 424. Such can ensure continuous optimization or improvement of storage volume placement decisions according to a defined optimization or improvement criterion.

Turning now to FIG. 6, a schematic flow diagram 600 is depicted illustrating an example process flow relating to determining node label information via NodeGetInfo calls in accordance with certain embodiments of this disclosure.

As illustrated with respect to reference numeral 602, vCSI 410 can perform a NodeGetInfo( ) call. At reference numeral 604, a response to the forgoing call can be used to find supported protocols on the node. In more detail, in the context of Kubernetes, the NodeGetInfo( ) call is part of the CSI specification and is invoked by a Kubelet to retrieve node-specific details from a CSI plugin, which in this case, can be vCSI driver 410. The response to NodeGetInfo( ) typically includes a NodeID and topology information. The Node ID can be a unique identifier used internally by associated CSI driver and Kubernetes to correlate volumes and attach/detach operations to the correct node. The topology information can represent labels or key-value pairs indicating the storage-related capabilities or connectivity available on this node (e.g., supported protocols or attached arrays).

At reference numeral 606, imported CSI drivers (e.g., existing CSI drivers 106) can be imported and can be leveraged to invoke independent NodeGetInfo() calls to the many different available storage systems illustrated here as Storage system A 608A, Storage system B 608B, Storage system C 608C, Storage system D 608D, and Storage system E 608E.

In accordance with the disclosed subject matter, which enables intelligent volume provisioning via a single CSI driver (e.g., vCSI 410) across heterogeneous storage systems, NodeGetInfo() plays a significant role in dynamic node labeling. For example, such can facilitate protocol awareness, array connectivity, volume provisioning and scheduling, among other useful aspects. In that regard, when NodeGetInfo( ) is called, vCSI driver 410 can examine which protocols (e.g., iSCSI, Fibre Channel, NFS, . . . ) are actually enabled or reachable from that node. In response, as indicated at reference numerals 610 and 612, vCSI 410 can generate nodel labels based on supported protocols. For example, vCSI 410 can return topology keys such as vcsi-vendor.com/iscsi, vcsi-vendor.com/fc, or vcsi-vendor.com/nfs. CO system 300 (e.g., Kubernetes) can then use these labels in scheduling decisions, ensuring that pods, which require a particular protocol, are placed on nodes with matching labels.

Regarding array connectivity, it is further noted that vCSI 410 can also track which storage arrays each node can connect to, then during NodeGetInfo( ), the driver can return additional labels indicating connectivity, e.g., a label indicating the node is wired to “Array123” via Fibre Channel. Such labels may look like vcsi-vendor.com/array123fc or vcsi-vendor.com/arrayXYZiscsi, making it clear which node can attach volumes from a particular array using the appropriate protocol.

Regarding volume provisioning and scheduling, it is observed that by exposing these node labels, the vCSI driver 410 can guide Kubernetes to schedule the pod on a node that matches the protocol or array selected by the Intelligent Volume Provisioning logic. Whenever vCSI driver 410 determines that an iSCSI-based volume from Array123 should be created, Kubernetes can ensure the volume will attach to a node that is labeled accordingly, preventing scheduling failures. In this manner, NodeGetInfo( ) (or similar) can provide a standardized way for vCSI driver 410 to publish node-level connectivity and protocol information, allowing the single vCSI driver's intelligent placement logic to function seamlessly with Kubernetes scheduling, ensuring volumes are always created, attached, and mounted on nodes capable of supporting the chosen storage configuration.

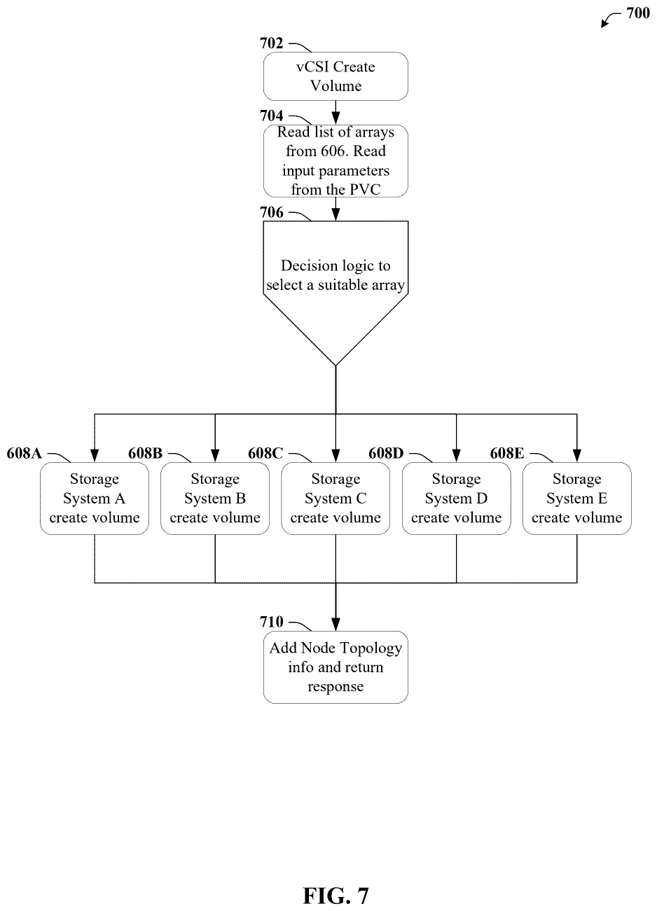

Turning now to FIG. 7, a schematic flow diagram 700 is depicted illustrating an example process flow relating to suitable storage arrays and determining topology in accordance with certain embodiments of this disclosure.

At reference numeral 702, vCSI 410 can operate to create a volume. For example, at reference numeral 704, vCSI 410 can read the list of arrays from imported CSI drivers. vCSI 410 can also read input parameters from the Persistent Volume Claim. At 706, vCSI 410 can invoke decision logic to select a suitable array from among the candidates indicated by reference numerals 608A-608E detailed previously. Thus, at reference numeral 710, vCSI 410 can add node topology info as detailed above and return a corresponding response.

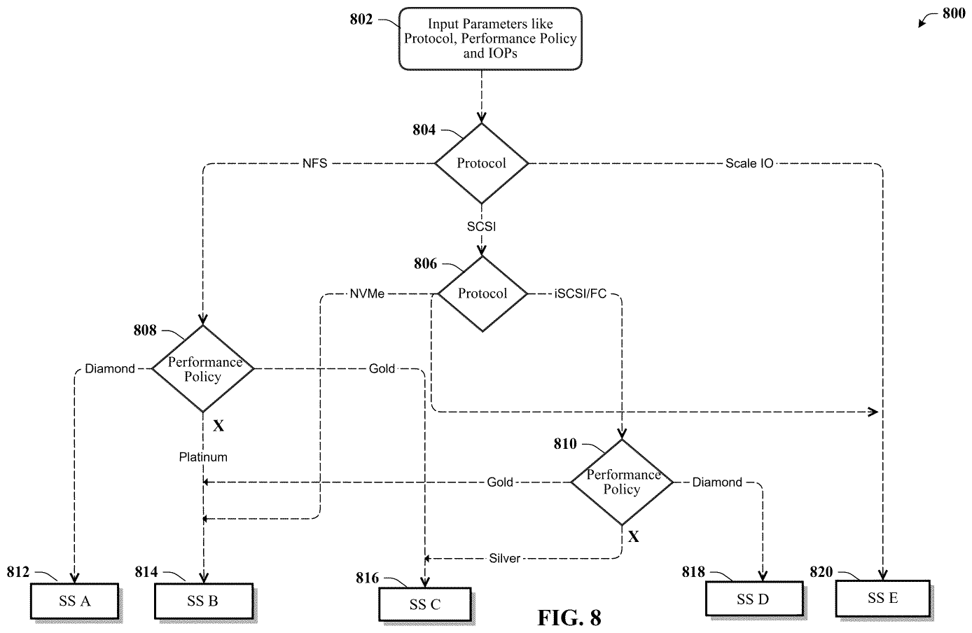

Referring now to FIG. 8, a flow diagram 800 is depicted illustrating an example process flow resulting from an example use case of vCSI driver 410 in accordance with certain embodiments of this disclosure. For instance, initially, certain input parameters can be received, as indicated at reference numeral 802. These input parameters can include, e.g., a protocol (e.g., protocol 128), performance policy (e.g., performance tier 130), IOPs, or another suitable parameter.

At reference numeral 804, depending on the particular protocol, the flow advances accordingly. For instance, NFS, SCSI, or scale IO can take different paths. At reference numeral 806, the type of SCSI can be determined such as NVMe, iSCSI, Fibre channel, and so on, and the path can vary accordingly as shown.

At reference numerals 808 and 810, different paths can be taken based on the performance policy. Ultimately, one of the available storage systems (e.g., storage systems 120 or 416) can be selected based on the input parameters. In this example scenario, there are five different storage systems labeled 812, 814, 816, 818, and 820. In this scenario, if the highest performance (e.g., diamond tier) is indicated, then storage system A 812 or storage system D 818 can be selected. If the protocol is NFS and platinum tier is indicated, then storage system B 814 can be selected, whereas if the gold tier is indicated then storage system C 816 can be selected, and so on as illustrated.

### Example Methods

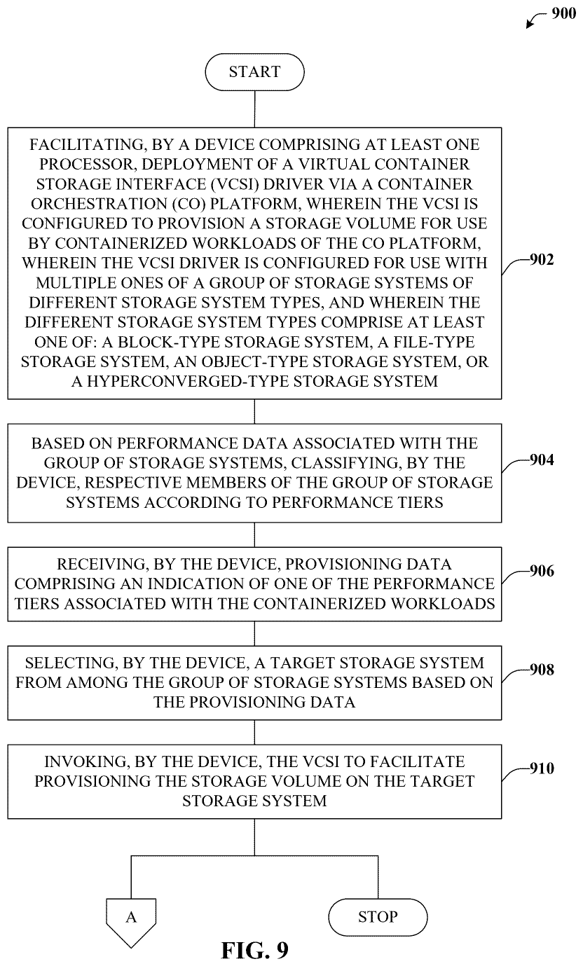

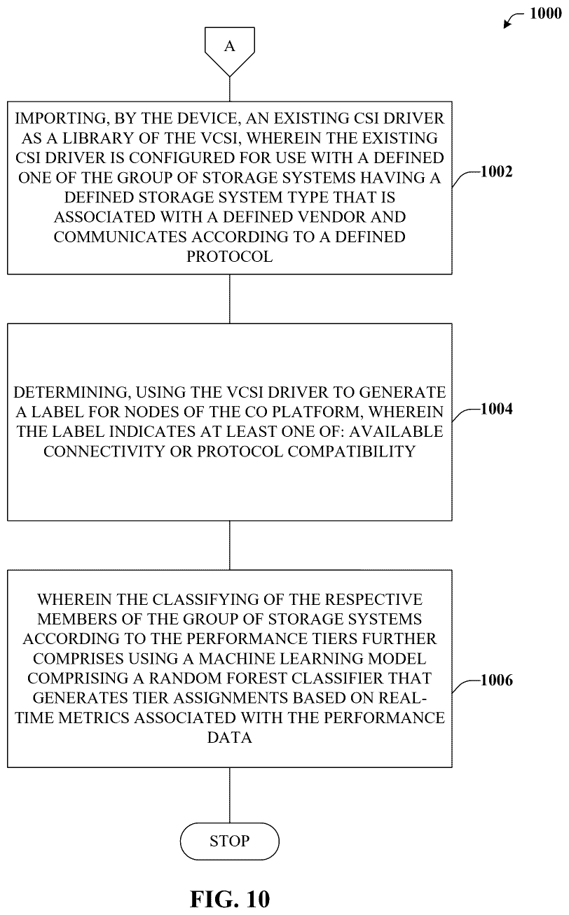

FIGS. 9 and 10 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 9, exemplary method 900 is depicted. Method 900 that can leverage a single vCSI driver to provision volumes across heterogeneous storage systems regardless of the type, vendor, protocol, or other storage system characteristic in accordance with certain embodiments of this disclosure. While method 900 describes a complete method, in some embodiments, method 900 can include one or more elements of method 1000, as illustrated by insert A.

At reference numeral 902, a device comprising at least one processor can facilitate deployment of a virtual container storage interface (vCSI) driver via a container orchestration (CO) platform. The vCSI can be configured to provision a storage volume for use by containerized workloads of the CO platform. The vCSI driver can further be configured for use with multiple ones of a group of storage systems of different storage system types. For example, the different storage system types can comprise at least one of: a block-type storage system, a file-type storage system, an object-type storage system, a hyperconverged-type storage system, or another suitable type of storage system, certain examples of which can be found with reference to FIG. 2A.

At reference numeral 904, based on performance data associated with the group of storage systems, the device can classify respective members of the group of storage systems according to performance tiers. This classification can be in accord with any suitable classification system (e.g., diamond, platinum, gold, silver, . . . ) using any suitable performance metrics (e.g., capacity, IOPs, latency, . . . ). Additional aspects or elements of the classification can be found at reference numeral 1006 of FIG. 10.

At reference numeral 906, the device can receive provisioning data. The provisioning data can comprise an indication of one of the performance tiers associated with the containerized workloads. In some embodiments, the provisioning data can further comprise optional control parameters that can be used to allow additional control over which storage system is selected for volume provisioning.

At reference numeral 908, the device can select a target storage system from among the group of storage systems based on the provisioning data (e.g., based on the indication of the performance tier and optional control parameters, if any). At reference numeral 910, the device can invoke the vCSI driver to facilitate provisioning of the storage volume on the target storage system. Method 900 can terminate or continue to insert A, which is further detailed in connection with FIG. 10.

Turning now to FIG. 10, exemplary method 1000 is depicted. Method 1000 can provide additional aspects or elements relating to leveraging the single vCSI driver to provision volumes across heterogeneous storage systems regardless of the type, vendor, protocol, or other storage system characteristic in accordance with certain embodiments of this disclosure.

At reference numeral 1002, the device introduced at reference numeral 902 comprising at least one processor can import an existing CSI driver as a library of the vCSI. For example, the existing CSI driver (e.g., CSI drivers 106) can be configured for use with a defined one of the group of storage systems having a defined storage system type that is associated with a defined vendor and communicates according to a defined protocol.

At reference numeral 1004, the device can use the vCSI driver to generate a label for nodes of the CO platform. This label can indicate certain requirements or constraints such as available connectivity, protocol compatibility, and so on.

At reference numeral 1006, the classifying the respective members of the of the group of storage systems introduced at reference numeral 904, can comprise using a machine learning model such as a supervised machine learning model. The machine learning model can comprise a random forest classifier that generates tier assignments based on real-time metrics associated with the performance data.

### Example Operating Environments

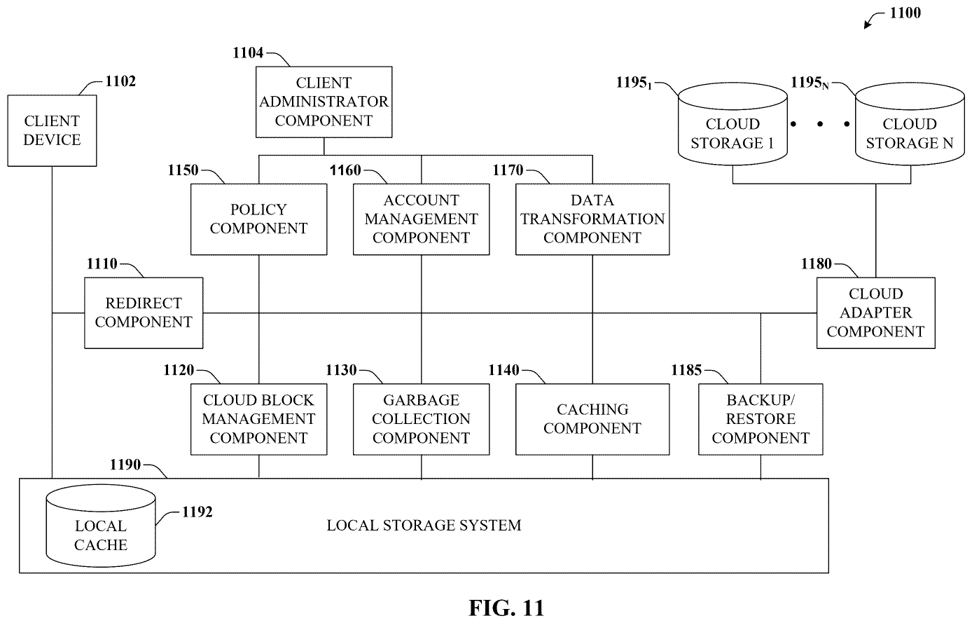

To provide further context for various aspects of the subject specification, FIGS. 11 and 12 illustrate, respectively, a block diagram of an example distributed file storage system 1100 that employs tiered cloud storage and block diagram of a computer 1202 operable to execute the disclosed storage architecture in accordance with aspects described herein.

Referring now to FIG. 11, there is illustrated an example local storage system including cloud tiering components and a cloud storage location in accordance with implementations of this disclosure. Client device 1102 can access local storage system 1190. Local storage system 1190 can be a node and cluster storage system such as an EMC Isilon Cluster that operates under OneFS operating system. Local storage system 1190 can also store the local cache 1192 for access by other components. It can be appreciated that the systems and methods described herein can run in tandem with other local storage systems as well.

As more fully described below with respect to redirect component 1110, redirect component 1110 can intercept operations directed to stub files. Cloud block management component 1120, garbage collection component 1130, and caching component 1140 may also be in communication with local storage system 1190 directly as depicted in FIG. 11 or through redirect component 1110. A client administrator component 1104 may use an interface to access the policy component 1150 and the account management component 1160 for operations as more fully described below with respect to these components. Data transformation component 1170 can operate to provide encryption and compression to files tiered to cloud storage. Cloud adapter component 1180 can be in communication with cloud storage 1 1195₁ and cloud storage N 1195_{N}, where N is a positive integer. It can be appreciated that multiple cloud storage locations can be used for storage including multiple accounts within a single cloud storage location as more fully described in implementations of this disclosure. Further, a backup/restore component 1185 can be utilized to back up the files stored within the local storage system 1190.

Cloud block management component 1120 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 9 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1120 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1160 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1120 based on list of mappings it manages. For example, each stub can be associated with an account, and the cloud block management component 1120 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1180 manages the sending and receiving of data to and from the cloud service providers. The cloud adapter component 1180 can utilize a set of APIs. For example, each cloud service provider may have provider specific API to interact with the provider.

A policy component 1150 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1130. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1130 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1140 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1120, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1140 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1140 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1170 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 1185 can transfer a copy of the files within the local storage system 1190 to another cluster (e.g., target cluster). Further, the backup/restore component 1185 can manage synchronization between the local storage system 1190 and the other cluster, such that, the other cluster is timely updated with new and/or modified content within the local storage system 1190.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the . NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1102.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
deploying, via a container orchestration (CO) platform, a virtual container storage interface (vCSI) driver configured to provision a storage volume for use by containerized workloads of the CO platform, wherein the vCSI driver is configured for use with any one of a group of storage systems comprising storage systems having different storage system types;
based on performance data associated with the group of storage systems, classifying respective members of the group of storage systems according to performance tiers;
receiving provisioning data comprising an indication of one of the performance tiers associated with the containerized workloads;
selecting a target storage system from among the group of storage systems based on the provisioning data; and
using the vCSI to provision the storage volume on the target storage system.

2. The device of claim 1, wherein the different storage system types comprise at least one of: a block-type storage system, a file-type storage system, an object-type storage system, a cloud-type storage system, or a hyperconverged-type storage system.

3. The device of claim 1, wherein the vCSI driver is configured to interact concurrently with different types of the different storage system types comprising ones of the storage systems that communicate according to different communication protocols or that are associated with different vendors.

4. The device of claim 1, wherein the operations further comprise using the vCSI driver to generate a label for nodes of the CO platform, wherein the label indicates at least one of: available connectivity or protocol compatibility, yielding an assurance that the storage volume is mounted only on nodes of the CO platform that support a type of the target storage system.

5. The device of claim 1, wherein the operations further comprise, based on results of monitoring the group of storage systems, generating the performance data that relates to performance metrics associated with the respective members of the group of storage systems.

6. The device of claim 5, wherein the performance metrics comprise at least one of: a storage capacity metric, an input/output performance metric, a network latency metric, or a protocol availability metric.

7. The device of claim 5, wherein the operations further comprise refreshing the performance data based on further results of further monitoring the group of storage systems.

8. The device of claim 1, wherein the classifying of the respective members of the group of storage systems according to the performance tiers comprises using a supervised machine learning model comprising a random forest classifier that generates tier assignments based on real-time metrics associated with the performance data.

9. The device of claim 8, wherein the random forest classifier is retrained or updated at predefined intervals or in response to significant changes in the performance data, thereby ensuring continuous optimization or improvement of storage placement decisions according to a defined optimization or improvement criterion.

10. The device of claim 1, wherein the provisioning data further comprises an optional parameter comprising at least one of: a specified protocol to be used in connection with the target system, a storage array identifier that identifies a particular storage array from among the group of storage systems, or a storage pool identifier that identifies a subgroup of the group of storage systems, thereby delegating control of a portion of volume provisioning manually or according to a defined semi-intelligent process.

11. The device of claim 1, wherein the operations further comprise importing, as a library of the vCSI, an existing CSI driver that is configured for use with a defined one of the group of storage systems having a defined storage system type that is associated with a defined vendor and communicates according to a defined protocol.

12. A method, comprising:
facilitating, by a device comprising at least one processor, deployment of a virtual container storage interface (vCSI) driver via a container orchestration (CO) platform, wherein the vCSI is configured to provision a storage volume for use by containerized workloads of the CO platform, wherein the vCSI driver is configured for use with multiple ones of a group of storage systems of different storage system types, and wherein the different storage system types comprise at least one of: a block-type storage system, a file-type storage system, an object-type storage system, or a hyperconverged-type storage system;
based on performance data associated with the group of storage systems, classifying, by the device, respective members of the group of storage systems according to performance tiers;
receiving, by the device, provisioning data comprising an indication of one of the performance tiers associated with the containerized workloads;
selecting, by the device, a target storage system from among the group of storage systems based on the provisioning data; and
invoking, by the device, the vCSI to facilitate provisioning the storage volume on the target storage system.

13. The method of claim 12, further comprising importing, by the device, an existing CSI driver as a library of the vCSI, wherein the existing CSI driver is configured for use with a defined one of the group of storage systems having a defined storage system type that is associated with a defined vendor and communicates according to a defined protocol.

14. The method of claim 12, further comprising using the vCSI driver to generate a label for nodes of the CO platform, wherein the label indicates at least one of: available connectivity or protocol compatibility.

15. The method of claim 12, wherein the classifying of the respective members of the group of storage systems according to the performance tiers further comprises using a machine learning model comprising a random forest classifier that generates tier assignments based on real-time metrics associated with the performance data.

16. A non-transitory computer-readable medium comprising instructions that, in response to execution, cause a system comprising a processor to perform operations, comprising:
facilitating deployment, on a container orchestration (CO) platform, of a virtual container storage interface (vCSI) driver configured to provision a storage volume for use by containerized workloads of the CO platform, wherein the vCSI driver is configured for use with any one of a group of storage systems comprising storage systems in which at least some members of the group of storage systems: have different storage system types, communicate according to different communication protocols, or are associated with different vendors;
based on performance data associated with the group of storage systems, classifying respective members of the group of storage systems according to performance tiers;
receiving provisioning data comprising an indication of one of the performance tiers associated with the containerized workloads;
selecting a target storage system from among the group of storage systems based on the provisioning data; and
using the vCSI for a provisioning of the storage volume on the target storage system.

17. The non-transitory computer-readable medium of claim 16, wherein the different storage system types comprise at least one of: a block-type storage system, a file-type storage system, a cloud-type storage system, or a hyperconverged-type storage system.

18. The non-transitory computer-readable medium of claim 16, wherein the operations further comprise using the vCSI driver to generate a label for nodes of the CO platform, and wherein the label indicates at least one of: available connectivity or protocol compatibility.

19. The non-transitory computer-readable medium of claim 16, wherein the classifying of the respective members of the group of storage systems according to the performance tiers comprises using a machine learning model comprising a random forest classifier that generates tier assignments based on most recently determined metrics associated with the performance data.

20. The non-transitory computer-readable medium of claim 16, wherein the operations further comprise importing, as a library of the vCSI, an existing CSI driver that is configured for use with a defined one of the group of storage systems having a defined storage system type that is associated with a defined vendor and communicates according to a defined protocol.
